(19) United States
(12) Patent Application Publication
(10) Pub. No.: US 2015/0053324 A1
(43) Pub. Date: Feb. 26, 2015

(54) TIRE HAVING LAMINATED INNERLINER WITH REINFORCED SPLICE

(71) Applicant: The Goodyear Tire & Rubber Company, Akron, OH (US)

(72) Inventors: Byoung Jo Lee, Copley, OH (US); John Fleming Brainerd, II, Medina, OH (US); Philip Alan Dunker, Stow, OH (US); Joseph Alan Incavo, The Woodlands, TX (US); Brandon Clifford Goad, Denver, CO (US)

(73) Assignee: The Goodyear Tire & Rubber Company, Akron, OH (US)

(21) Appl. No.: 13/972,971

(22) Filed: Aug. 22, 2013

(51) Int. Cl. B60C 5/14; B29D 30/06

(52) U.S. Cl. CPC B60C 5/14; B29D 30/0681; B29D 2030/0682; B60C 2005/145; B60C 2005/147
USPC 152/510; 156/123

(57) ABSTRACT

The present invention relates to pneumatic tires having a laminated innerliner with reinforced splice. The laminated innerliner is a pre-formed laminate comprised of an innerliner film which contains an RFL adhesive coating on both sides for which the innerliner film is cohesively bonded through the RFL adhesive to an uncured tire rubber carcass ply. The uncured splice is comprised of overlapping end portions of the uncured laminated innerliner cohesively bonded together through the RFL adhesive which provides building tack. The uncured splice is reinforced by a an uncured rubber strip cohesively bonded to the laminate by the building tack-providing RFL adhesive for which the strip abridges, the overlapping end portions of the splice, or is sandwiched between the overlapped end portions of the splice, to form a cohesively bonded composite. The assembly, or composite, thereof is cured to adhesively bond the splice and rubber strip together.

### FIELD OF THE INVENTION

The present invention relates to pneumatic tires having a laminated innerliner with reinforced splice. The laminated innerliner is a pre-formed laminate comprised of an innerliner film which contains an RFL adhesive coating on both sides for which the innerliner film is cohesively bonded through the RFL adhesive to an uncured tire rubber carcass ply. The uncured splice is comprised of overlapping end portions of the uncured laminated innerliner cohesively bonded together through the RFL adhesive which provides building tack. The uncured splice is reinforced by an uncured rubber strip cohesively bonded to the laminate by the building tack-providing RFL adhesive for which the strip abridges, the overlapping end portions of the splice, or is sandwiched between the overlapped end portions of the splice, to form a cohesively bonded composite. The assembly, or composite, thereof is cured to adhesively bond the splice and rubber strip together.

### BACKGROUND OF THE INVENTION

Pneumatic tires usually contain barrier layers to retard permeation of atmospheric air or oxygen. Such barrier layers are usually in a form of innerliner layers for the tires which are typically comprised of butyl or halogenated butyl rubber (e.g. halobutyl rubber) based rubber compositions which have greater resistance to permeability of air or oxygen than other rubber components of the tire. The barrier layers, or innerliners, are provided to inhibit, or retard, the loss of air or oxygen from the pneumatic tire cavity through the barrier layer into the tire carcass which thereby promotes retention of air, including retention of air pressure, within the pneumatic tire cavity. In order to provide a suitable degree of air or oxygen impermeability, the innerliner layer is typically provided as a sufficiently thick layer which, in turn, may add significant weight to the tire. Further, an additional rubber layer, sometimes referred to as a rubber tie layer, with beneficially low hysteresis loss, may be positioned, or sandwiched, between the barrier layer and the tire rubber carcass. For the description of this invention, such rubber tie layer is considered as being a part of the tire carcass. Such barrier layers for pneumatic rubber tires are well known to those having skill in such art.

As indicated above, the thickness of the butyl or halogenated butyl rubber based barrier layer may add to the weight of the tire. Accordingly, alternate thinner materials with low air or oxygen permeability may be desired, particularly in a form of thin films, for use as the barrier layer. Various candidates which are relatively impermeable to air or oxygen have heretofore been proposed for use as air barriers in tires, including, for example, non-elastomeric films of polyvinylidene chloride, nylon, and polyester. For example, see U.S. Pat. Nos. 5,040,583 and 4,928,741. Composites containing films have been proposed for use as air barriers in tires such as, for example, at least one layer of a thin film of such non-elastomeric barrier material sandwiched and bonded between elastomer layers of elastomeric compositions.

Thin films of alloys (alloy film) with a resistance to air and/or oxygen permeability have also been proposed for a tire innerliner layer comprised of, for example, an alloy of thermoplastic resin (as a continuous phase) which may contain a blend or dispersion of elastomer domains (as a discontinuous phase) or other thermoplastic resin. Optionally, such alloy may contain a binder resin to enhance the compatibility between the thermoplastic resin and dispersed elastomer domains.

Advantageously, films of such low air/oxygen permeable alloys can be significantly thinner than their conventional butyl rubber-based counterpart tire innerliners and can therefore promote a tire weight savings.

The alloy films may be provided, for example, as a strip which is coated on one or both sides with an RFL adhesive to promote adhering of overlapping ends of the strip together, particularly where the strip is in a form of a circumferential hoop positioned on, or intended to be positioned on, the inside surface of a pneumatic tire carcass.

For this invention, is desired to provide a barrier layer in a form of a pre-formed laminated innerliner with reinforced adhesive bonded splice. The splice is comprised of overlapping ends of the laminated innerliner. The laminated innerliner is a pre-formed laminate comprised of an innerliner film adhesively bonded to a tire carcass cord reinforced rubber ply.

The splice of overlapped ends of the laminated innerliner is reinforced by a rubber layer adhesively bonded to the laminate which extends over overlapped ends of the splice, or is positioned between the overlapped ends of the bonded splice to form an adhesively bonded composite.

The innerliner film is comprised of a composite of an alloy film coated on both sides with an RFL adhesive to provide building tack between the innerliner film and uncured tire carcass rubber ply and to be thereby cohesively adhered, or bonded, by the RFL adhesive to a tire carcass cord reinforced rubber ply to provide a pre-formed laminate. In one aspect, the cord reinforced rubber carcass ply is provided to provide support for the thin alloy film. The pre-formed laminate is positioned circumferentially around, or intended to be positioned around, the inner surface of the tire cavity within a pneumatic rubber tire with ends of the laminate overlapping each other in an overlapping configuration.

The aforesaid building tack for the uncured component(s) before curing the uncured component(s), referred to herein as cohesive bonding, is provided by the RFL adhesive. Upon curing the component(s), such as by sulfur curing, the components become adhesively bonded together by the RFL adhesive. It is a feature of this invention for building tack for building the components comprised of the laminated innerliner, the splice and rubber strip reinforcement applied to the splice to be provided by the RFL adhesive, which is referred to herein as being a co-adhesive for a co-adhesive bond (through the building tack) and later becoming a more secure adhesive bond upon curing (e.g. sulfur curing) of composite comprised of the components.

Therefore, in practice, it is desired for the ends of the uncured laminate to overlap each other to form a splice and for the overlapped end portions of the laminate to be RFL cohesively bonded together by the RFL adhesive coating.

However, it is envisioned that considerable stress is placed on the RFL cohesively bonded splice as the uncured rubber tire is expanded during the tire building process during which the diameter of the uncured tire is increased.

Therefore, as indicated above, it is proposed to evaluate reinforcing the cohesively bond the splice of the RFL coated overlapped ends of the uncured laminate by at least one of:

(A) providing a rubber strip overlay over at least one of its spliced ends which extends over and is cohesively bonded by the RFL adhesive to the splice and to a portion of the surfaces of the laminate which adjoin the spliced end (adjoin the splice),

(B) providing a rubber strip positioned between and cohesively bonded to the overlapped portions of the laminate (at the splice), and

(C) providing an extension of the alloy film beyond the splice and thereby beyond the cord reinforced rubber carcass ply ends of the laminate to overlay and cohesively bond to a surface of the laminate.

### SUMMARY AND PRACTICE OF THE INVENTION

In accordance with this invention, a tire is provided which contains a circumferential tire tread, an underlying and supporting carcass comprised of at least one cord reinforced rubber ply extending from separate spaced apart tire beads through the crown of the tire (underlying and supporting the circumferential tire tread) and a pre-formed laminated tire innerliner layer, (pre-formed in a sense of the innerliner laminate being formed prior to application to the tire);

where said pre-formed laminated innerliner (the pre-formed laminate) is comprised of an alloy film cohesively bonded to an uncured tire carcass cord reinforced rubber ply;

where both sides of said alloy film contain an RFL adhesive coating;

where said alloy film is cohesively bonded to said uncured cord reinforced rubber tire carcass ply by said RFL coating on said alloy film;

where the pre-formed laminated innerliner layer is a circumferential innerlayer of the tire having its ends joined together in an overlapped configuration to thereby form an RFL cohesively bonded splice;

where the rubber composition of said rubber tire carcass ply is comprised of at least one diene-based elastomer, without a butyl or halobutyl based rubber (thereby exclusive of butyl and halobutyl rubber);

where the alloy film is comprised of at least 50 percent by weight of a thermoplastic polymer comprised of at least one of nylon or polyester terephthalate (desirably nylon) and a minor portion of at least one of:

(A) dispersion of elastomer domains comprised of at least one diene-based elastomer, and

(B) polymer comprised of at least one of polyalkylene glycol (e.g. at least one of polyethyleneglycol, polypropyleneglycol and polytetramethylene glycol), polyoxyalkylene diamine (e.g. at least one of polyoxyethylene diamine, polyoxypropylene diamine and polyoxytetramethylene diamine) and copolymers thereof,

where the splice of the RFL coated overlapped ends of the laminate is reinforced by at least one of:

(C) a rubber strip positioned over a spliced end of said laminate at said splice and extending over and RFL cohesively bonded to surfaces of the laminate adjoining the spliced end,

(D) a rubber strip positioned between and RFL cohesively bonded to the overlapped surfaces of the laminate at the splice, and

(E) a portion of the alloy film extending beyond the splice and the cord reinforced rubber carcass ply ends of the laminate which is RFL cohesively bonded to surfaces of the laminate.

wherein said RFL adhesive is comprised of a resorcinol-formaldehyde resin/styrene-butadiene vinylpyridine latex optionally containing a styrene-butadiene rubber latex, and optionally containing a blocked isocyanate.

In additional accordance with this invention the tire is provided as a cured rubber tire (e.g. a sulfur cured rubber tire) with the splice and rubber strip reinforcement being adhesively bonded together by said RFL adhesive.

In further accordance with this invention, a method of preparing a pneumatic tire comprises:

(A) applying a pre-formed laminated innerliner uncured layer around a cylindrical tire building drum,

(B) overlapping the ends of the applied laminated uncured innerliner to form a splice, and

(C) reinforcing the splice by at least one of:
(1) application of a rubber strip over the splice which extends over the splice ends and is RFL cohesively bonded to the splice and to surfaces of the laminate adjoining the splice,
(2) application of a rubber strip between and RFL cohesively bonded to the overlapped surfaces of the laminate adjoining the splice, and
(3) providing an extension of the RFL coated alloy film beyond the splice and the cord reinforced rubber carcass ply ends of the laminate which is cohesively bonded to surfaces of the laminate by said RFL adhesive coating;

where the rubber strip is comprised of at least one sulfur curable diene-based elastomer,

wherein said pre-formed laminated uncured innerliner layer (the pre-formed laminate) is comprised of an alloy film adhesively bonded to a tire carcass cord reinforced rubber ply;

wherein both sides of said alloy film contain an RFL adhesive coating;

wherein said alloy film is cohesively bonded to said cord reinforced rubber tire carcass ply by said RFL coating on said alloy film;

wherein the rubber composition of said rubber tire carcass ply is comprised of at least one diene-based elastomer, without a butyl or halobutyl based rubber (thereby exclusive of butyl and halobutyl rubber),

wherein the alloy film is comprised of at least 50 percent by weight of a thermoplastic polymer comprised of at least one of nylon or polyester terephthalate (desirably nylon) and a minor portion of at least one of:

(D) dispersion of elastomer domains comprised of at least one diene-based elastomer, and

(E) polymer comprised of at least one of polyalkylene glycol (e.g. at least one of polyethyleneglycol, polypropyleneglycol and polytetramethylene glycol), polyoxyalkylene diamine (e.g. at least one of polyoxyethylene diamine, polyoxypropylene diamine and polytetramethylene diamine) and copolymers thereof,

wherein said RFL adhesive is comprised of a resorcinol-formaldehyde resin/styrene-butadiene vinylpyridine latex optionally containing a styrene-butadiene rubber latex, and optionally containing a blocked isocyanate.

In one embodiment the method is further comprised of curing the tire (e.g. curing the tire in a mold at an elevated temperature such as, for example, in a range of from about 150 to about 180° C.) and thereby providing the splice and protective rubber strip adhesively bonded together by said RFL adhesive.

In practice, said RFL adhesive is a well known resorcinol-formaldehyde resin/butadiene-styrene-vinyl pyridine terpolymer latex, or a blend thereof with a butadiene/styrene rubber latex, used in the tire industry for application to fabrics, fibers and textile cords for aiding in their adherence to rubber components (for example, see U.S. Pat. No. 4,356,219) although not understood as being applied to the multi-layered composite of this invention which is considered herein to be a significant departure from past practice. Suitable particulate polyamide may be made for example following the methods of U.S. Pat. No. 7,740,938 and application of an RFL adhesive to particles of polyaramide for use in a tire may be used. For example, see U.S. Pat. No. 8,299,165.

In practice, as indicated, the film may be pretreated by the RFL coating to enhance interaction, namely to promote bonding, with the rubber composition.

In one embodiment, the film is treated, namely coated, with an aqueous RFL emulsion comprised of combination or resorcinol-formaldehyde resin, and one or more indicated elastomer latexes, and the coating dried to remove water.

In one embodiment, the RFL for said coating may include the resorcinol formaldehyde resin, a styrene-butadiene copolymer latex and vinylpyridine-styrene-butadiene terpolymer latex. In a further embodiment, the RFL may also include a blocked isocyanate.

In one embodiment, the RFL adhesive composition is comprised of

(A) resorcinol,

(B) formaldehyde,

(C) a styrene-butadiene rubber latex,

(D) a vinylpyridine-styrene-butadiene terpolymer latex, and, optionally,

(E) a blocked isocyanate.

The resorcinol reacts with formaldehyde to produce a resorcinol-formaldehyde reaction product. This reaction product is the result of a condensation reaction between a phenol group on the resorcinol and the aldehyde group on the formaldehyde. Resorcinol resoles and resorcinol-phenol resoles, whether formed in situ within the latex or formed separately in aqueous solution, are considerably superior to other condensation products in the adhesive mixture.

For preparation of an RFL adhesive, for example, the resorcinol may be dissolved in water to which formaldehyde has been added (for example, about 37 percent formaldehyde) together with a strong base such as sodium hydroxide. The strong base should generally constitute around 7.5 percent or less of the resorcinol, and the molar ratio of the formaldehyde to resorcinol should be in a range of from about 1.5 to about 2. The aqueous solution of the resole or condensation product or resin is mixed with the styrene-butadiene latex and vinylpyridine-styrene-butadiene terpolymer latex. The resole or other mentioned condensation product or materials that form said condensation product should, for example, constitute from 5 to 40 parts and more desirably about 10 to about 28 parts by weight solids of the latex mixture. The condensation product forming the resole or resole type resin forming materials should desirably be partially reacted or reacted so as to be only partially soluble in water. Sufficient water is then preferably added to give around 12 percent to 28 percent by weight overall solids in the final mixture. The weight ratio of the polymeric solids from the latex to the resorcinol/formaldehyde resin should, for example, be in a range of about 2/1 to about 6/1.

In one embodiment, the RFL adhesive may include a blocked isocyanate. For example, about 1 to about 8 parts by weight of solids of a blocked isocyanate is added to the adhesive. The blocked isocyanate may be any suitable blocked isocyanate known to be used in RFL adhesive dips including, but not limited to, caprolactam blocked methylene-bis-(4-phenylisocyanate), such as Grilbond-IL6 available from EMS American Grilon, Inc., and phenol formaldehyde blocked isocyanates as disclosed in U.S. Pat. Nos. 3,226,276; 3,268,467; and 3,298,984; the three of which are fully incorporated herein by reference. As a blocked isocyanate, use may be made of reaction products between one or more isocyanates and one or more kinds of isocyanate blocking agents. The isocyanates include monoisocyanates such as phenyl isocyanate, dichlorophenyl isocyanate and naphthalene monoisocyanate, diisocyanate such as tolylene diisocyanate, dianisidine diisocyanate, hexamethylene diisocyanate, m-phenylene diisocyanate, tetramethylene diisocyante, alkylbenzene diisocyanate, m-xylene diisocyanate, cyclohexylmethane diisocyanate, 3,3-dimethoxyphenylmethane-4,4′-diisocyanate, 1-alkoxybenzene-2,4-diisocyanate, ethylene diisocyanate, propylene diisocyanate, cyclohexylene-1,2-diisocyanate, diphenylene diisocyanate, butylene-1,2-diisocyanate, diphenylmethane-4,4diisocyanate, diphenylethane diisocyanate, 1,5-naphthalene diisocyanate, etc., and triisocyanates such as triphenylmethane triisocyanate, diphenylmethane triisocyanate, etc. The isocyanate-blocking agents include phenols such as phenol, cresol, and resorcinol, tertiary alcohols such as t-butanol and t-pentanol, aromatic amines such as diphenylamine, diphenylnaphthylamine and xylidine, ethyleneimines such as ethylene imine and propyleneimine, imides such as succinic acid imide, and phthalimide, lactams such as epsilon-caprolactam, delta-valerolactam, and butyrolactam, ureas such as urea and diethylene urea, oximes such as acetoxime, cyclohexanoxime, benzophenon oxime, and alpha-pyrolidon.

The polymers of the RFL adhesive composition may be applied in a form of an aqueous latex or otherwise, usually in a form of a latex. In one embodiment, for example, a vinylpyridine-styrene-butadiene terpolymer latex and styrene-butadiene rubber latex may be added to the RFL adhesive composition. The vinylpyridine-styrene-butadiene terpolymer may be present in the RFL adhesive such that the solids weight of the vinylpyridine-styrene-butadiene terpolymer is from about 50 percent to about 100 percent of the solids weight of the styrene-butadiene rubber; in other words, the weight ratio of vinylpyridine-styrene-butadiene terpolymer to styrene-butadiene rubber is from about 1/1 to about 2/1.

In further accordance with this invention, said tire assembly is provided as a sulfur vulcanized composite. Such vulcanization may be conducted, for example, under conditions of elevated temperature and pressure as would be well known to those having skill in such art of rubber vulcanization.

In practice, said innerliner barrier composite is a pre-formed multilayered, film-containing, composite, as previously described, and the pre-formed composite built into the tire to form the uncured tire assembly of rubber components after which the tire assembly is vulcanized under conditions of elevated temperature and pressure in a suitable tire mold to form a tire comprised of integral components.

A significant aspect of this invention, as previously indicated, is the inclusion of the RFL cohesive coating on both sides of the film and the RFL coated film is adhered to the surface of an uncured diene-elastomer containing rubber composition of said tire carcass ply with the RFL cohesive layer therebetween.

This configuration of the pre-formed multi-layered uncured composite is considered to be significant in a sense of enabling the uncured composite to have suitable flexibility and elasticity for tire manufacturing processes and tire service under tire operating conditions while also providing a suitable barrier for air and/or oxygen.

Representative of sulfur vulcanizable elastomers of said tire carcass to which said RFL adhesive is in contact may be comprised of, for example, cis 1,4-polyisoprene, cis 1,4-polybutdiene and styrene/butadiene copolymer rubbers.

### BRIEF DESCRIPTION OF THE DRAWINGS

The figures (FIG's) contained in the accompanying drawings are presented to illustrate several embodiments of the reinforced laminated innerliner of the invention.

### The Drawings

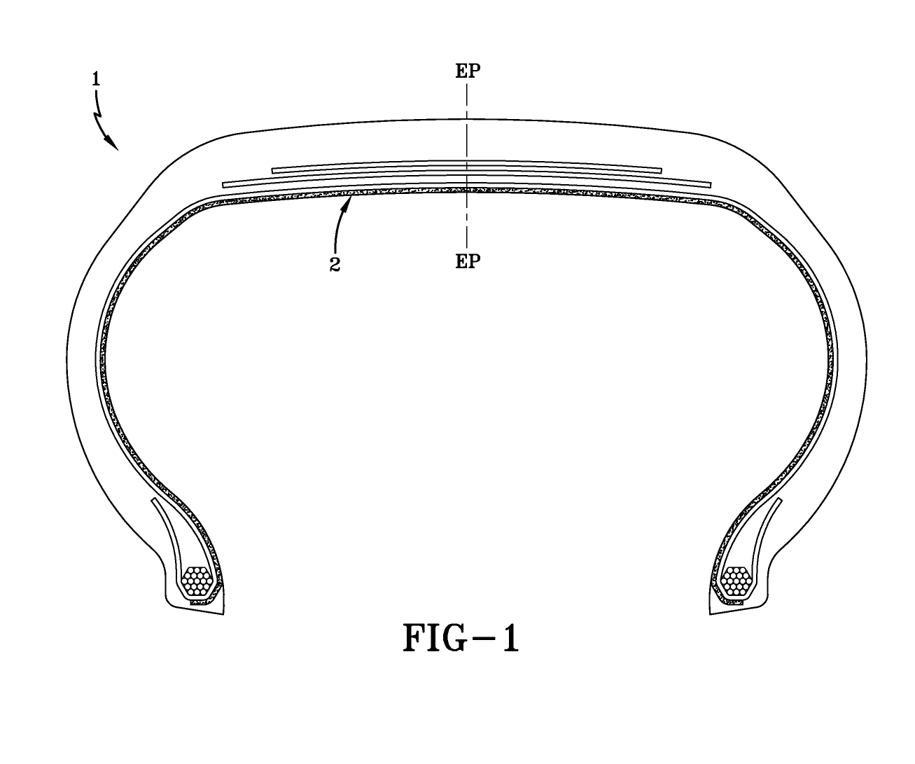

FIG. 1 illustrates a cross-sectional view of a pneumatic tire (1) containing a laminated innerliner layer composite (2), composed of an alloy film bonded to a carcass rubber ply, by an RFL adhesive (not shown). The indicated “EP” represents a center line of the tire (1).

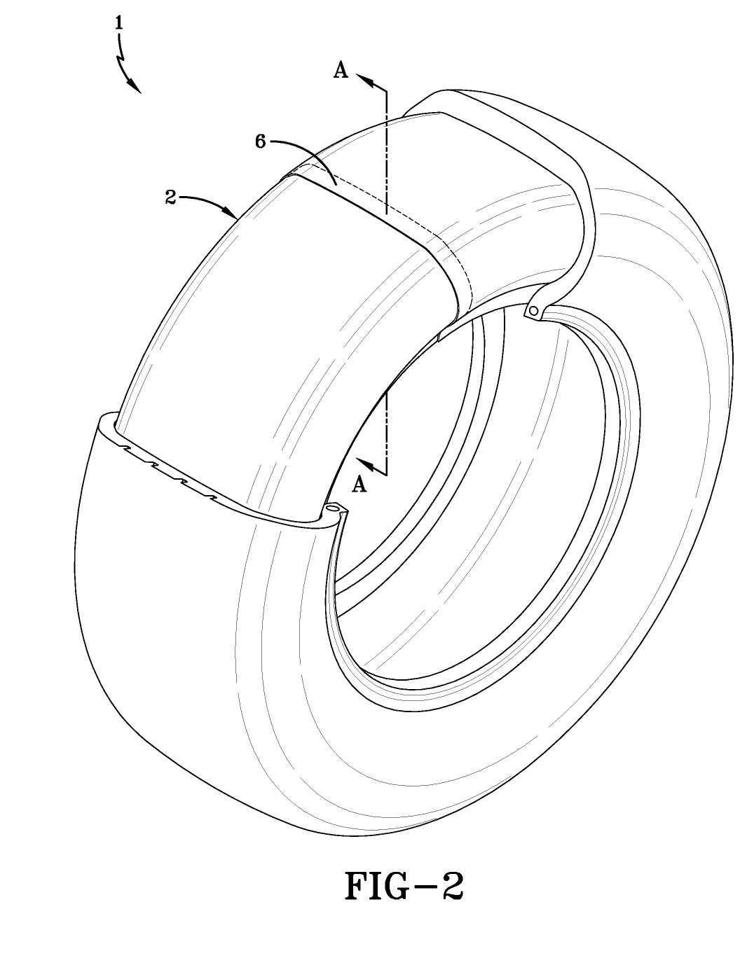

FIG. 2 is a perspective view of the tire (1) illustrating a circumferential laminated innerliner layer (2) having its ends overlapped to form a splice (6). The ends of the innerliner layer (2) become spliced upon being wrapped around a cylindrical tire building drum (not shown).

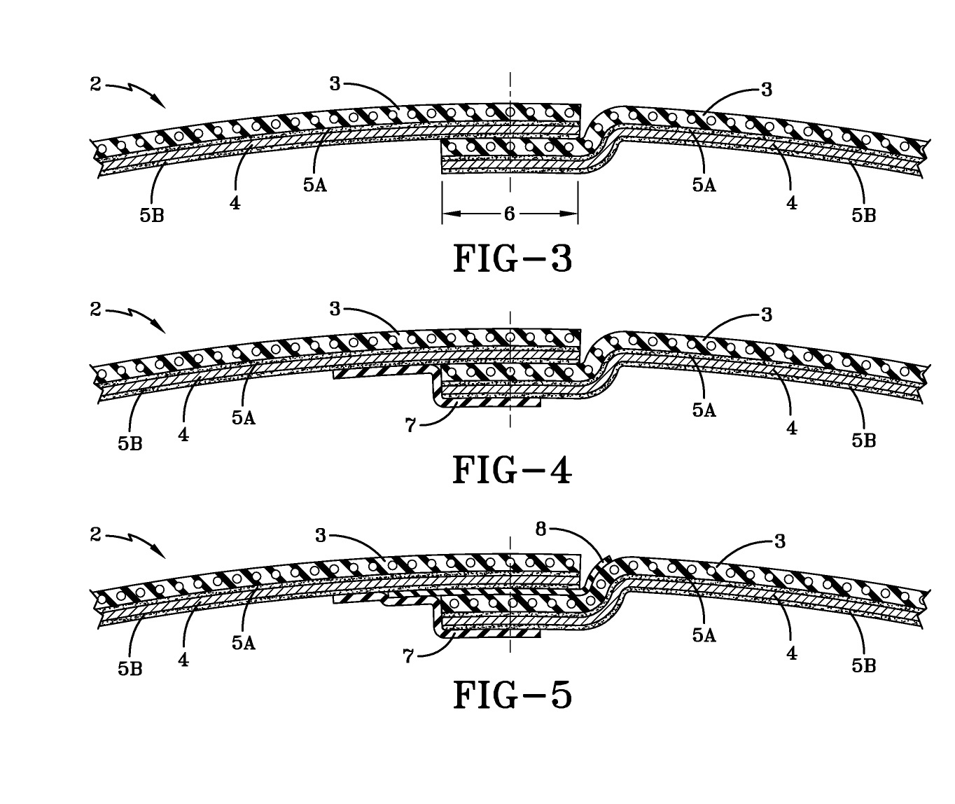

FIGS. 3, 4 and 5 are enlarged cross sectional views taken along lines A-A of FIG. 2 to further illustrate the splice (6) of the overlapped end portion of the circumferential laminated innerliner layer (2) composed of a thin alloy film (4) with RFL adhesive coatings (5A) and (5B) on either side of the alloy film (4) to adhesively bond the alloy film (4) to the cord reinforced rubber tire carcass ply (3) and particularly RFL adhesive coating (5B) bonding the overlapped portion of the laminate layer (3) at the splice (6).

FIG. 3 is a cross sectional view of the splice (6) of the overlapped end portion of the laminated innerliner layer (2) composed of an alloy film RFL adhesive bonded to a carcass rubber ply.

FIG. 4 is the cross sectional view of FIG. 3 which illustrates a reinforcing rubber layer or cover strip (7) applied over a spliced end of the overlapped laminated innerliner layer (2) at the splice (6) where the rubber cover strip (7) extends over and is RFL adhesive bonded to the splice and to a surface of the laminated innerliner layer (2), namely its alloy film (4), which adjoins either side of the splice (6) by the RFL adhesive coatings (5A) and (5B), respectively. The rubber cover strip (7) does not contain (is exclusive of) cord reinforcement.

FIG. 5 illustrates the laminated innerliner layer (2) with its ends overlapped to form an RFL adhesive bonded splice (6) of FIG. 4 with an addition of an intermediate rubber strip (8) positioned between (sandwiched between) and RFL adhesively bonded to the overlapped surfaces of the laminated innerliner (2), namely to surfaces of the alloy film (4) at the splice (6) through the RFL adhesive coatings (5A) and (5B), respectively.

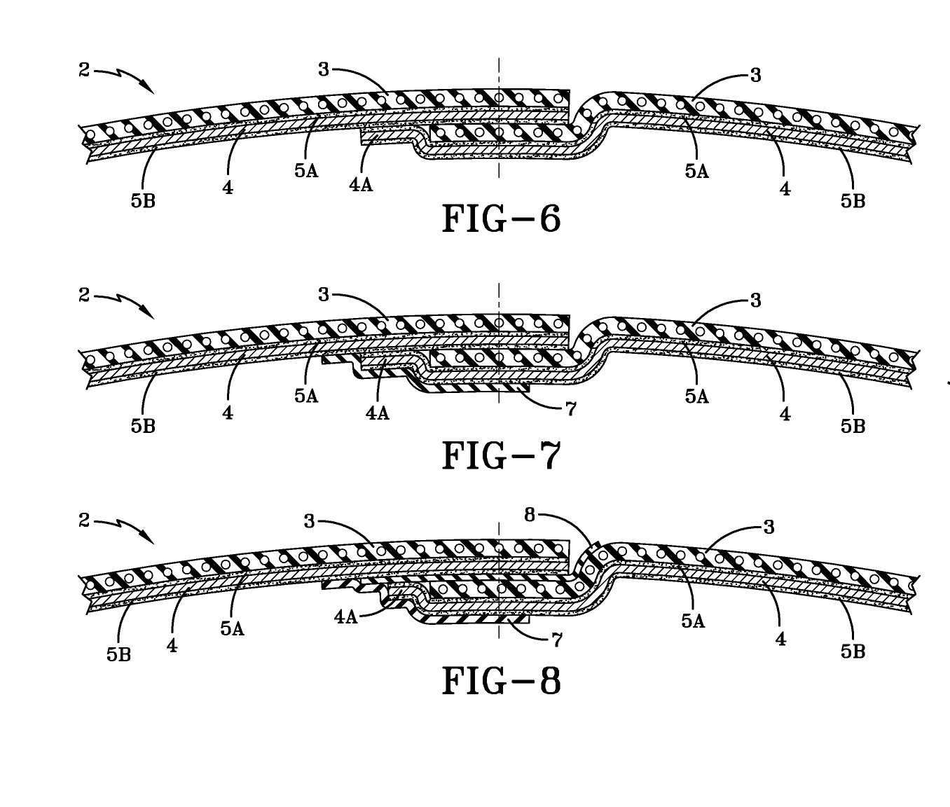

FIGS. 6, 7 and 8 are similar to FIGS. 3, 4 and 5, respectively, except that a reinforcement of the splice (6) is provided by an extension (4A) of the alloy film (4) with its RFL adhesive coatings (5A) and (5B) is provided which extends beyond the splice (6) and which is adhered to the laminated innerliner (2) through both RFL adhesive coatings (5A) and (5B).

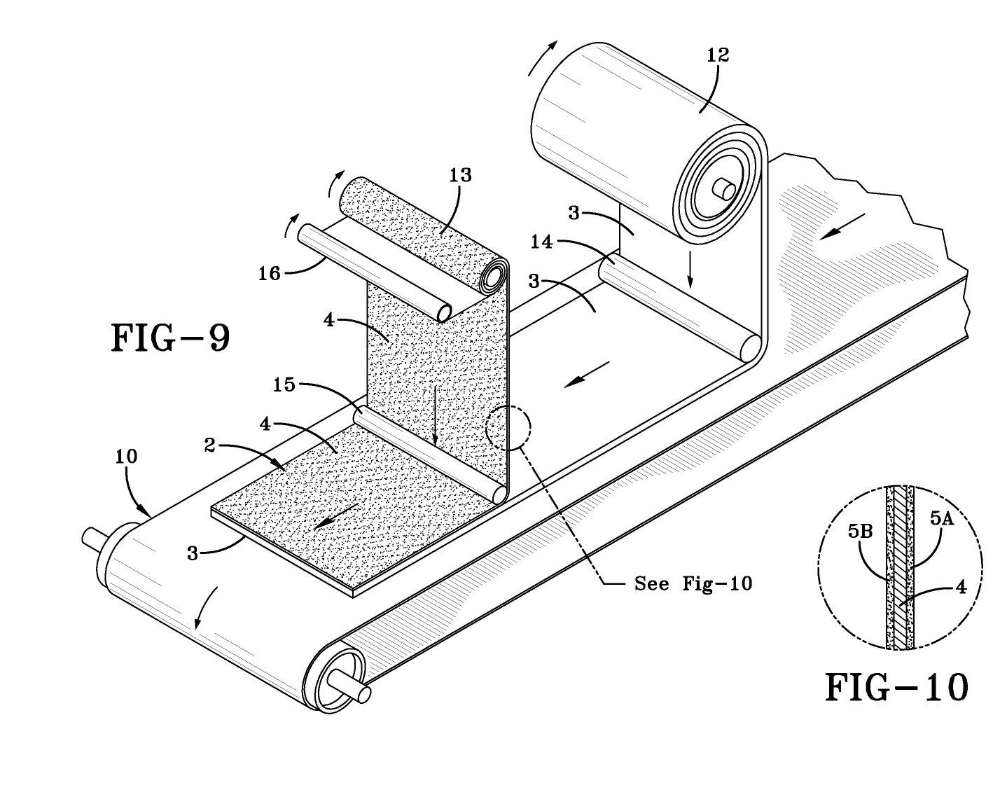

FIGS. 9 and 10 are provided to illustrate an example of preparation of the pre-formed laminated innerliner (2).

FIG. 9 shows a conveyor belt (10), let-off rolls (12) and (13), a take-up roll (16) and control bars (14) and 15).

With reference to FIG. 9, for preparation of the laminated innerliner (2), a cord reinforced rubber carcass ply (3) is fed from a let-off roll (12) onto the moving conveyor belt (10) with an adjustably positioned control bar (14) controlling placement of the rubber carcass ply (3) onto the conveyor belt (10).

With further reference to FIG. 9, An alloy film (4), with an RFL adhesive coated on both of its sides, is fed from its let-off roll (13) and applied to the top side of the already deposited rubber carcass ply (3) on the moving conveyor belt (10) with its placement on the carcass ply controlled by an adjustably positioned control bar (15). A take-up roll (16) is provided to take up a protective, adhesive resistant, film, or paper, fed from the let-off roll 13 which had been inter-leaved between rolled up layers of the adhesive layer-containing alloy film (4) for storage purposes.

With additional reference to FIG. 9, The resultant laminated composite, namely a pre-formed laminated innerliner composite (2) is rolled on a take-up roll (not shown) from the moving conveyor belt (10) and stored for later use.

FIG. 10 is an expanded view of the alloy film (4) shown in FIG. 9 which illustrates the RFL adhesive coating on both sides as RFL coatings (5A) and (5B). The RFL coatings are the same and simply labeled in FIG. 10 as (5A) and (5B) for convenience.

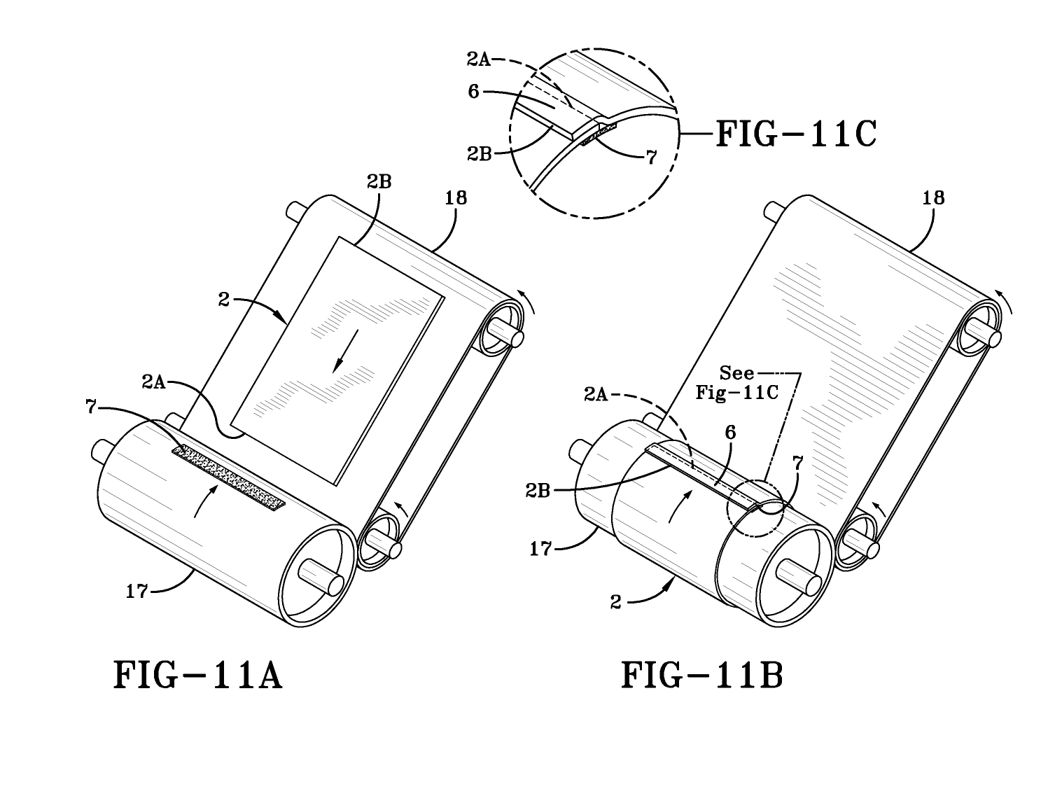

FIGS. 11A and 11B illustrate an example of application of the pre-formed laminated innerliner (2) onto a tire building drum (10) to form a splice (6) in advance of building the rest of the tire (not shown) onto the pre-formed innerliner layer (2).

With reference to FIG. 11A, the reinforcing rubber strip (7), exclusive of cord reinforcement, is applied to the building drum (17) in a manner shown in FIG. 11A.

The pre-formed innerliner laminate (2) is shown as being positioned on a moving conveyor belt (18) with its leading edge (2A) positioned in the direction of the rotating building drum (17) and its following edge (2B) on the opposite end of the innerliner laminate (2).

With reference to FIG. 11B, the pre-formed innerliner laminate (2) is shown as being wound around the tire building drum (17) in a manner that its leading edge (2A) is positioned over the reinforcing rubber strip (7) and its following edge (2B) is positioned over the innerliner laminate (2) on the rotating building drum (17) to from the splice (6) in a manner shown in FIG. 11B.

The multilayered laminate of barrier layer composite (2) is presented with its end portions overlapped to form a splice (6) on the rotating building drum (17) to include the reinforcing rubber strip (7) which is RFL adhesively bonded to the innerliner laminate (2) of the splice (6) contrast to the ends (2A) and (2B) of the innerliner laminate (2) being end-to-end butt spliced.

With reference to FIG. 11C, an enlarged portion of FIG. 11B the resulting splice (6) is more clearly shown as being comprised of the reinforcing rubber strip (7) abridging the leading edge (2A) of the innerliner laminate (2) and the innerliner laminate (2) itself and with the following edge (2B) of the innerliner laminate (2) overlaying the innerliner laminate (2).

In practice, the alloy film (4) may be either a nylon or polyester terephthalate based film, desirably a nylon based film, containing a blend of sulfur curable elastomer domains or additional thermoplastic material.

Exemplary of the nylon of the nylon based film layer is, for example, nylon 6, nylon 66 or nylon 6,66, particularly nylon 6.

Polyvinylidinechloride is not desired because to it is unnecessarily subject to degradation in the presence of moisture for the innerliner barrier, and thereby the innerliner composite, of this invention as well as other polymeric films such as polyethylene and films of other polyolefins which have inadequate air impermeability as well as polyvinylchloride based films.

The thin polymeric film (nylon or polyethylene terephthalate polyester) for the barrier layer may have a film thickness, for example, from about 25 to about 200 microns. Alternately the thickness of the thin film may range from about 50 microns to about 150 microns.

The aforesaid thin polymeric film for the barrier layer may have an oxygen permeability, for example, of less than 20×10⁻¹² cc-cm/cm²·sec·cmHg. Desirably, the aforesaid polymeric film for the barrier layer may also have an elongation, for example, of at least about 200 percent at about 23° C. As such, it is intended that, when used as the barrier layer of the tire, the polymeric film is not intended to break during the tire shaping process.

For the bonding of the innerliner, or barrier layer, composite to the tire carcass, the RFL adhesive is desired instead of other adhesive materials such as, for example, rosin-based resins; terpene-based resins; petroleum resins; cumarin-indene resins; styrene based resin other than said RFL adhesive; alkylphenol resins; a polyester polyol/isocyanate-type resins; an acrylic acid ester copolymer/organic peroxide-type resins; and reinforced polyurethane adhesive (RPU) resins.

The RFL adhesive may be applied to the innerliner composite by various methods including, for example, as spray coating, dip coating, or extrusion coating. The thickness of the RFL adhesive coating may be, for example, within the range from about 0.5 microns to about 10, alternately from about 0.5 microns to about 5 microns.

The rubber compositions for the rubber tire carcass layer and the rubber layer for the innerliner composite can contain conventional rubber tire additives to provide a desired rubber property as would be applied by one having skill in the appropriate art. Such known and commonly used additive materials may include, for example, sulfur cure activators, retarders and accelerators, rubber processing oils, resins including tackifying resins, plasticizers, fatty acids, zinc oxide, waxes, antidegradant, antiozonants, and peptizing agents.

The uncured tire assembly can be molded and sulfur cured in a suitable tire mold at an elevated temperature and pressure conditions as would be appreciated and known to those having skill in such art.

It is concluded that application of the uncured, sulfur curable, rubber strip over the splice ends of the uncured tire innerliner composite strip, which is bonded to the alloy film of the innerliner composite by the RFL adhesive coating, provides significant reinforcement of the splice to respond to stress caused by expansion of the uncured tire during its building.

It is further concluded that application of the uncured, sulfur curable, rubber strip between (sandwiched between) the overlaying end portions of the innerliner composite at the splice and bonded to the alloy film of the innerliner composite by the RFL adhesive coating at the splice provides significant reinforcement of the splice to respond to stress caused during the building of the tire.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicants' general inventive concept.

What is claimed is:

1. A tire which contains a circumferential tire tread, an underlying and supporting carcass comprised of at least one cord reinforced rubber ply extending from separate spaced apart tire beads through the crown of the tire and a pre-formed laminated tire innerliner layer, where said pre-formed laminated innerliner is comprised of an alloy film cohesively bonded to an uncured tire carcass cord reinforced rubber ply;
where both sides of said alloy film contain an RFL adhesive coating;
where said alloy film is cohesively bonded to said uncured cord reinforced rubber tire carcass ply by said RFL coating on said alloy film;
where the pre-formed laminated innerliner layer is a circumferential innerlayer of the tire having its ends joined together in an overlapped configuration to thereby form an RFL cohesively bonded splice;
where the rubber composition of said rubber tire carcass ply is comprised of at least one diene-based elastomer, without a butyl or halobutyl based rubber,
where the alloy film is comprised of at least 50 percent by weight of a thermoplastic polymer comprised of at least one of nylon or polyester terephthalate and a minor portion of at least one of:
(A) dispersion of elastomer domains comprised of at least one diene-based elastomer, and
(B) polymer comprised of at least one of polyalkylene glycol, polyoxyalkylene diamine and copolymers thereof,
where the splice of the RFL coated overlapped ends of the laminate is reinforced by at least one of:
(C) a rubber strip positioned over a spliced end of said laminate at said splice and extending over and RFL cohesively bonded to surfaces of the laminate adjoining the spliced end,
(D) a rubber strip positioned between and RFL cohesively bonded to the overlapped surfaces of the laminate at the splice, and
(E) a portion of the alloy film extending beyond the splice and the cord reinforced rubber carcass ply ends of the laminate which is RFL cohesively bonded to surfaces of the laminate.
wherein said RFL adhesive is comprised of a resorcinol-formaldehyde resin/styrene-butadiene vinylpyridine latex optionally containing a styrene-butadiene rubber latex, and optionally containing a blocked isocyanate,
wherein the reinforcing rubber strip is comprised of at least one sulfur curable diene-based elastomer.

2. The tire of claim 1 wherein the splice of the RFL coated overlapped ends of the laminate is reinforced by a rubber strip positioned over a spliced end of said laminate at said splice and extending over and RFL cohesively bonded to surfaces of the laminate adjoining the spliced end.

3. The tire of claim 1 wherein the splice of the RFL coated overlapped ends of the laminate is reinforced by a rubber strip positioned between and RFL cohesively bonded to the overlapped surfaces of the laminate at the splice.

4. The tire of claim 1 wherein the splice of the RFL coated overlapped ends of the laminate is reinforced by a portion of the alloy film extending beyond the splice and the cord reinforced rubber carcass ply ends of the laminate which is RFL cohesively bonded to surfaces of the laminate.

5. The tire of claim 1 wherein the alloy film is comprised of at least 50 percent by weight of a thermoplastic polymer comprised of nylon.

6. The tire of claim 1 wherein the alloy film is comprised of at 50 percent by weight of a thermoplastic polymer comprised of polyester terephthalate.

7. The tire of claim 1 wherein where the alloy film is comprised of at least 50 percent by weight of a thermoplastic polymer comprised of at least one of nylon or polyester terephthalate and a minor portion of a dispersion of elastomer domains comprised of at least one diene-based elastomer.

8. The tire of claim 1 wherein the alloy film is comprised of at least 50 percent by weight of a thermoplastic polymer comprised of at least one of nylon or polyester terephthalate and a minor portion of polymer comprised of at least one of polyalkylene glycol, polyoxyalkylene diamine and copolymers thereof

9. The tire of claim 1 wherein the alloy film is comprised of at least 50 percent by weight of a thermoplastic polymer comprised of at least one of nylon or polyester terephthalate and a minor portion of polymer comprised of at least one of polyethyleneglycol, polypropyleneglycol, polytetramethylene glycol polyoxyethylene diamine, polyoxypropylene diamine polytetramethylene diamine and copolymers thereof.

10. The tire of claim 1 as a sulfur cured rubber tire.

11. A method of preparing a pneumatic tire which comprises:
(A) applying a pre-formed laminated innerliner uncured layer around a cylindrical tire building drum,
(B) overlapping the ends of the applied laminated uncured innerliner to form a splice, and
(C) reinforcing the splice by at least one of:
(1) application of a rubber strip over the splice which extends over the splice ends and is RFL cohesively bonded to the splice and to surfaces of the laminate adjoining the splice,
(2) application of a rubber strip between and RFL cohesively bonded to the overlapped surfaces of the laminate adjoining the splice, and
(3) providing an extension of the RFL coated alloy film beyond the splice and the cord reinforced rubber carcass ply ends of the laminate which is cohesively bonded to surfaces of the laminate by said RFL adhesive coating;
wherein said reinforcing rubber strip is comprised of at least one sulfur curable diene-based elastomer,
wherein said pre-formed laminated uncured innerliner layer is comprised of an alloy film adhesively bonded to a tire carcass cord reinforced rubber ply;
wherein both sides of said alloy film contain an RFL adhesive coating;
wherein said alloy film is cohesively bonded to said cord reinforced rubber tire carcass ply by said RFL coating on said alloy film;
wherein the rubber composition of said rubber tire carcass ply is comprised of at least one diene-based elastomer, without a butyl or halobutyl based rubber (thereby exclusive of butyl and halobutyl rubber),
wherein the alloy film is comprised of at least 50 percent by weight of a thermoplastic polymer comprised of at least one of nylon or polyester terephthalate and a minor portion of at least one of:
(D) dispersion of elastomer domains comprised of at least one diene-based elastomer, and
(E) polymer comprised of at least one of polyalkylene glycol, polyoxyalkylene diamine and copolymers thereof,
wherein said RFL adhesive is comprised of a resorcinol-formaldehyde resin/styrene-butadiene vinylpyridine latex optionally containing a styrene-butadiene rubber latex, and optionally containing a blocked isocyanate.

12. The method of claim 11 wherein the splice of the RFL coated overlapped ends of the laminate is reinforced by a rubber strip positioned over a spliced end of said laminate at said splice and extending over and RFL cohesively bonded to surfaces of the laminate adjoining the spliced end.

13. The method of claim 1 wherein the splice of the RFL coated overlapped ends of the laminate is reinforced by a rubber strip positioned between and RFL cohesively bonded to the overlapped surfaces of the laminate at the splice.

14. The method of claim 1 wherein the splice of the RFL coated overlapped ends of the laminate is reinforced by a portion of the alloy film extending beyond the splice and the cord reinforced rubber carcass ply ends of the laminate which is RFL cohesively bonded to surfaces of the laminate.

15. The method of claim 1 wherein the alloy film is comprised of at least 50 percent by weight of a thermoplastic polymer comprised of nylon.

16. The method of claim 1 wherein the alloy film is comprised of at 50 percent by weight of a thermoplastic polymer comprised of polyester terephthalate.

17. The method of claim 1 wherein where the alloy film is comprised of at least 50 percent by weight of a thermoplastic polymer comprised of at least one of nylon or polyester terephthalate and a minor portion of a dispersion of elastomer domains comprised of at least one diene-based elastomer.

18. The method of claim 1 wherein the alloy film is comprised of at least 50 percent by weight of a thermoplastic polymer comprised of at least one of nylon or polyester terephthalate and a minor portion of polymer comprised of at least one of polyalkylene glycol, polyoxyalkylene diamine and copolymers thereof.

19. The method of claim 1 wherein the alloy film is comprised of at least 50 percent by weight of a thermoplastic polymer comprised of at least one of nylon or polyester terephthalate and a minor portion of polymer comprised of at least one of polyethyleneglycol, polypropyleneglycol, polytetramethylene glycol polyoxyethylene diamine, polyoxypropylene diamine polytetramethylene diamine and copolymers thereof.

20. The method of claim 1 which further comprises curing the tire.
